(19) United States
(12) Patent Application Publication
(10) Pub. No.: US 2023/0385744 A1
(43) Pub. Date: Nov. 30, 2023

(54) MACHINE LEARNING ENABLED ENGAGEMENT CONTROLLER

(71) Applicant: SAP SE, Walldorf (DE)

(72) Inventors: Krishna Hindhupur Vijay Sudheendra, Bangalore (IN); Sandeep Hebbar, Bengaluru (IN); Nithya Rajagopalan, Bangalore (IN); David Morel, Nashville, TN (US)

(21) Appl. No.: 17/828,377

(22) Filed: May 31, 2022

(51) Int. Cl. G06Q 10/06; G06N 20/00

(52) U.S. Cl. CPC G06Q 10/06395; G06N 20/00

(57) ABSTRACT

A method may include receiving, from a first supplier, a first response to a sourcing event. A machine learning model to may be applied to determine a performance metric for the first response. The machine learning model being trained to determine, based on the terms included in the first response, the performance metric to indicate a relative competitiveness of the first response and a second response from a second supplier. One or more terms from the first response may be identified, based on an output of the machine learning model, as candidates for modification. A user interface may be generated to display a recommendation for the first supplier to modify the one or more terms of the first response. Related systems and computer program products are also provided.

### TECHNICAL FIELD

The subject matter described herein relates generally to machine learning and more specifically to a machine learning enabled controller for performance based engagement coordination of sourcing events.

### BACKGROUND

An enterprise may rely on a suite of enterprise software applications for sourcing, procurement, supply chain management, invoicing, and payment. The operations of the enterprise may also give rise to a variety of electronic documents including, for example, purchase orders, sales contracts, licensing agreements, and/or the like. As such, the enterprise software applications may integrate various electronic document management features. For example, an electronic document may include structured data, which may be stored in a data repository such as a relational database, a graph database, an in-memory database, a non-SQL (NoSQL) database, a key-value store, a document store, and/or the like. The enterprise software applications may manage an electronic document throughout its lifecycle, including creation, compliance, execution, and archiving.

### SUMMARY

Systems, methods, and articles of manufacture, including computer program products, are provided for machine learning enabled engagement coordination. In some example embodiments, there is provided a system that includes at least one processor and at least one memory. The at least one memory may include program code that provides operations when executed by the at least one processor. The operations may include: receiving, from a first client device associated with a first supplier, a first response to a sourcing event; preprocessing the first response by at least vectorizing at least a portion of data comprising the first response to deformalize the data; applying, to the preprocessed first response, a machine learning model to determine a first performance metric associated with the first response, the machine learning model being trained to determine, based at least on a first plurality of terms included in the first response, the first performance metric to indicate a relative competitiveness of the first response and at least a second response responsive to the sourcing event, the machine learning model being trained to determine a variance between the first plurality of terms included in the first response and a second plurality of terms comprising one or more responses awarded one or more previous sourcing events and to generate an output including a term-specific variance between each term of the first plurality of terms included in the first response and a corresponding term of a second plurality of terms comprising one or more responses awarded one or more previous sourcing events; identifying, based at least on the output of the machine learning model, one or more terms of the first plurality of terms as candidates for modification; and generating, for display at the first client device, a user interface including a recommendation to modify the one or more terms.

In some variations, one or more features disclosed herein including the following features can optionally be included in any feasible combination. The operations may further include: receiving, in response to the recommendation, a third response from the first supplier, the third response including the one or more modified terms; and determining, based at least on a second plurality of terms comprising the second response and a third plurality of terms comprising the third response, to reward the sourcing event to one of the second response associated with the second supplier and the third response associated with the first supplier.

In some variations, the machine learning model may be trained to determine a variance between the first plurality of terms included in the first response and a second plurality of terms comprising one or more responses awarded one or more previous sourcing events.

In some variations, the output of the machine learning model may include a term-specific variance between each term of the first plurality of terms included in the first response and a corresponding term of a second plurality of terms comprising one or more responses awarded one or more previous sourcing events.

In some variations, the one or more terms may be identified as candidates for modification based at least on the one or more terms being associated with a highest term-specific variance and/or an above-threshold term-specific variance.

In some variations, the operations may further include: training, based at least on data associated with one or more previous sourcing events, the machine learning machine model.

In some variations, the data associated with the one or more previous sourcing events may include an event data comprising at least one of title, description, region, start date, or end date.

In some variations, the data associated with the one or more previous sourcing events may include a line item data comprising at least one of a commodity, discount amount, discount percentage, price, incumbent price, surcharge, delivery charge, bundle lot price, or quantity.

In some variations, the data associated with the one or more previous sourcing events may include a supplier data comprising at least one of a turnover, time in operation, risk index, previous awards, or incumbent price.

In some variations, the data associated with the one or more previous sourcing events may include a bid data comprising at least one of a line item, competitive term value, or non-competitive term value.

In some variations, the data associated with the one or more previous sourcing events may include an award data comprising at least one of a supplier awarded, line item awarded, quantity of award, or price of award.

In some variations, the data associated with the one or more previous sourcing events may include one or more grading values associated with each supplier and/or line item.

In some variations, the one or more previous sourcing events may be associated with a same purchaser as the sourcing event.

In some variations, the machine learning model may include a regression model.

In some variations, the machine learning model may include one or more of a support vector machine (SMV) regression model, a ridge regression model, or a lasso regression model.

In some variations, the user interface may be further generate to include the first performance metric and/or a first ranking of the first supplier corresponding to the first performance metric.

In some variations, the operations may further include: receiving, from a second client device associated with a second supplier, the second response; and applying the machine learning model to determine a second performance metric associated with the second response.

In some variations, the operations may further include: receiving, in response to the recommendation, one or more user inputs modifying the one or more terms; applying the machine learning model to determine an updated performance metric corresponding to the one or more modified terms; and generating the user interface to display, at the first client device, the updated performance metric.

In another aspect, there is provided a method for machine learning enabled engagement coordination. The method may include: receiving, from a first client device associated with a first supplier, a first response to a sourcing event; preprocessing the first response by at least vectorizing at least a portion of data comprising the first response to denormalize the data; applying, to the preprocessed first response, a machine learning model to determine a first performance metric associated with the first response, the machine learning model being trained to determine, based at least on a first plurality of terms included in the first response, the first performance metric to indicate a relative competitiveness of the first response and at least a second response responsive to the sourcing event, the machine learning model being trained to determine a variance between the first plurality of terms included in the first response and a second plurality of terms comprising one or more responses awarded one or more previous sourcing events and to generate an output including a term-specific variance between each term of the first plurality of terms included in the first response and a corresponding term of a second plurality of terms comprising one or more responses awarded one or more previous sourcing events; identifying, based at least on the output of the machine learning model, one or more terms of the first plurality of terms as candidates for modification; and generating, for display at the first client device, a user interface including a recommendation to modify the one or more terms.

In another aspect, there is provided a computer program product including a non-transitory computer readable medium storing instructions. The instructions may cause operations may executed by at least one data processor. The operations may include: receiving, from a first client device associated with a first supplier, a first response to a sourcing event; preprocessing the first response by at least vectorizing at least a portion of data comprising the first response to denormalize the data; applying, to the preprocessed first response, a machine learning model to determine a first performance metric associated with the first response, the machine learning model being trained to determine, based at least on a first plurality of terms included in the first response, the first performance metric to indicate a relative competitiveness of the first response and at least a second response responsive to the sourcing event, the machine learning model being trained to determine a variance between the first plurality of terms included in the first response and a second plurality of terms comprising one or more responses awarded one or more previous sourcing events and to generate an output including a term-specific variance between each term of the first plurality of terms included in the first response and a corresponding term of a second plurality of terms comprising one or more responses awarded one or more previous sourcing events; identifying, based at least on the output of the machine learning model, one or more terms of the first plurality of terms as candidates for modification; and generating, for display at the first client device, a user interface including a recommendation to modify the one or more terms.

Implementations of the current subject matter can include methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes, it should be readily understood that such features are not intended to be limiting. The claims that follow this disclosure are intended to define the scope of the protected subject matter.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts a system diagram illustrating an example of a procurement system, in accordance with some example embodiments;

FIG. 2 depicts a block diagram illustrating an example of a dataflow within a procurement system, in accordance with some example embodiments;

FIG. 3 depicts a block diagram illustrating an example architecture of a procurement system, in accordance with some example embodiments;

FIG. 4 depicts a block diagram illustrating an example of a dataflow within a procurement system, in accordance with some example embodiments;

FIG. 5 depicts a flowchart illustrating an example of a process for performance based engagement coordination of a sourcing event, in accordance with some example embodiments; and

FIG. 6 depicts a block diagram illustrating an example of a computing system, in accordance with some example embodiments; and

When practical, similar reference numbers denote similar structures, features, or elements.

### DETAILED DESCRIPTION

Enterprise software applications may provide a variety of procurement and supply chain management solutions while integrating document management features for the electronic documents (e.g., purchase orders, sales contracts, licensing agreements, and/or the like) that may arise as a part of the process. However, conventional enterprise procurement solutions fail to maximize supplier engagement during sourcing events. In particular, conventional enterprise procurement solutions do not leverage the abundance data arising from current and past sourcing events to drive individual supplier performance during sourcing events. In the absence of competitive insights, the suppliers participating in a sourcing event are generally unable to maximize the competitiveness of their responses (e.g., electronic bids and/or the like), thus impairing the outcome of the sourcing event.

In some example embodiments, a procurement engine may include a machine learning enabled engagement controller to implement, during various sourcing events, performance based engagement coordination. For example, the engagement controller may be determine, for each supplier participating in a sourcing event, a performance metric indicative of a relative competitiveness of the response (e.g., electronic bids and/or the like) associated with each supplier. In some cases, the performance metrics may be determined by applying a machine learning model to the responses from the suppliers participating in the sourcing event. Moreover, the engagement controller may identify, based at least on an output of the machine learning model, one or more modifications to improve the competitiveness of the individual responses. To maximize supplier engagement, the engagement controller may generate recommendations that include the modifications to improve the competitiveness of each supplier's response. These recommendations may be provided in real time such that the suppliers participating in the sourcing event may submit modified responses (e.g., electronic bids and/or the like) with more competitive terms that are associated with a higher likelihood of being awarded with the sourcing event.

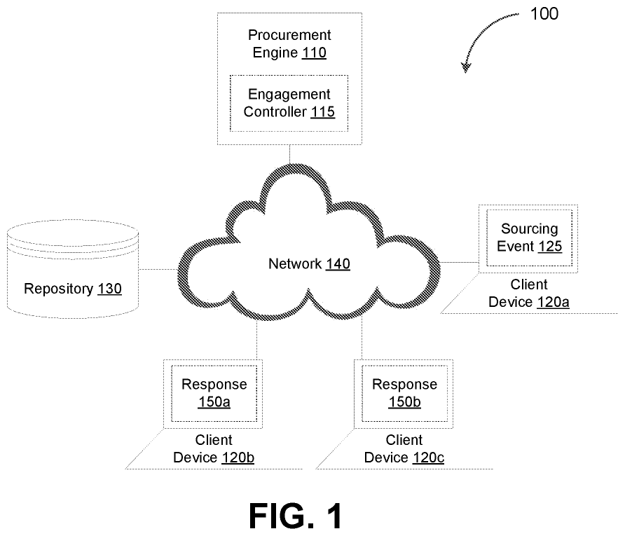

FIG. 1 depicts a system diagram illustrating an example of a procurement system 100, in accordance with some example embodiments. Referring to FIG. 1, the procurement system 100 may include a procurement engine 110 including an engagement controller 115, one or more client devices 120, and a repository 130. The engagement controller 115, the client device 120, and the repository 130 may be communicatively coupled via a network 140. The one or more client devices 120 may be a processor-based device including, for example, a smartphone, a tablet computer, a wearable apparatus, a virtual assistant, an Internet-of-Things (IoT) appliance, and/or the like. The repository 130 may be a database including, for example, a relational database, a non-structured query language (NoSQL) database, an in-memory database, a graph database, a key-value store, a document store, and/or the like. The network 140 may be any wired network and/or a wireless network including, for example, a wide area network (WAN), a local area network (LAN), a virtual local area network (VLAN), a public land mobile network (PLMN), the Internet, and/or the like.

The procurement engine 110 may be configured to coordinate a sourcing event 125 created at a first client device 120a by at least inviting one or more suppliers to participate in the sourcing event 125, receiving responses (e.g., electronic bids and/or the like) from the participating suppliers such as a first response 150a from a second client device 120b associated with a first supplier and a second response 150b from a third client device 130c associated with a second supplier, and awarding the sourcing event 125 to one or more of the participating suppliers. According to some example embodiments, the procurement engine 110 may leverage data associated with current and past sourcing events stored in the repository 130 to drive individual supplier performance during the sourcing event 125. For example, the engagement controller 115 may apply one or more machine learning models to implement, during the sourcing event 125, performance based engagement coordination.

In some example embodiments, the engagement controller 115 may be determine, for each supplier participating in a sourcing event, a performance metric indicative of a relative competitiveness of the responses (e.g., electronic bids and/or the like) received from each supplier. For example, in some cases, the performance metrics may be determined by applying a machine learning model to the responses received from the suppliers participating in the sourcing event 125. In the example shown in FIG. 1, for instance, the engagement controller 115 may determine a first performance metric for the first response 150a that is indicative of the competitiveness of the first response 150a relative to the second response 150b. Moreover, the engagement controller 115 may identify, based at least on the output of the machine learning model, one or more modifications to improve the competitiveness of the first response 150a. For instance, the engagement controller 115 may determine modifications to improve the competitiveness of the first response 150a if the first response 150a is associated with a below-threshold performance metric.

To maximize supplier engagement, the engagement controller 115 may generate, for example, for display at the second client device 120b, recommendations that include the modifications to improve the competitiveness of the first response 150a. These recommendations may be provided in real time such that the suppliers participating in the sourcing event 125 may submit modified responses with more competitive terms that are associated with a higher likelihood of being awarded the sourcing event 125.

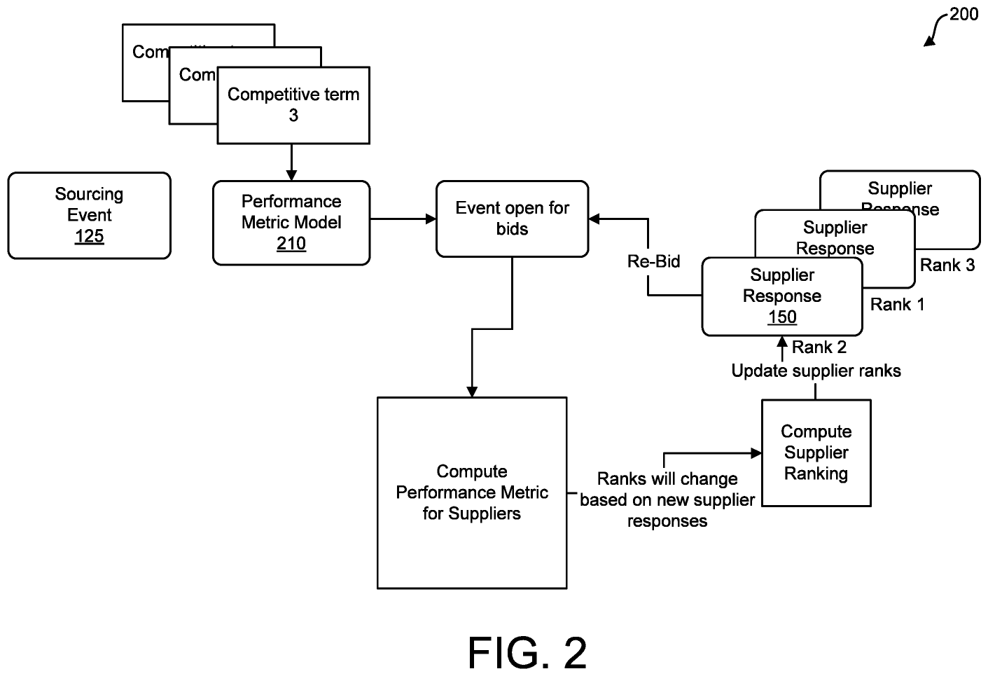

To further illustrate, FIG. 2 depicts a block diagram illustrating an example dataflow 200 within the procurement system 100, in accordance with some example embodiments. Referring to FIG. 2, in response to the creation of the sourcing event 125, the engagement controller 115 may apply a performance metric model 210 to determine, for example, a first performance metric for the first response 150a received from the second client device 120b and a second performance metric for the second response 150b received from the third client device 120c. Moreover, the engagement controller 115 may determine, based at least on the first performance metric of the first response 150a and the second performance metric of the second response 150b, a relative ranking for the corresponding suppliers. Accordingly, the supplier associated with the first response 150a may be assigned a higher ranking than the supplier associated with the second response 150b if the first performance metric of the first response 150a is higher than the second performance metric of the second response 150b. In some cases, each supplier's performance metric and relative ranking may be provided in real time to encourage the submission of modified responses (e.g., electronic bids) with more competitive terms to improve each supplier's performance metric and relative ranking.

Referring again to FIG. 2, in some example embodiments, the performance metric model 210 may be a custom model, including a machine learning model, implemented based on criteria specified by a purchaser associated with the sourcing event 125. Examples of such criteria may include certain terms such as one or more of a total price, currency, quantity, quality, brand, discounts, and surcharge associated with each supplier's response (e.g., electronic bid). Accordingly, by applying the performance metric model 210, the first performance metric and the second performance metric may be computed to reflect how well the respective terms of the first response 150a and the second response 150b match the criteria specified by the purchaser associated with the sourcing event 125. Moreover, by providing each supplier's performance metric and relative ranking in real time, the engagement controller 115 may encourage the submission of responses (and modified responses) with terms that are better suited to the criteria specified by the purchaser associated with the sourcing event 125.

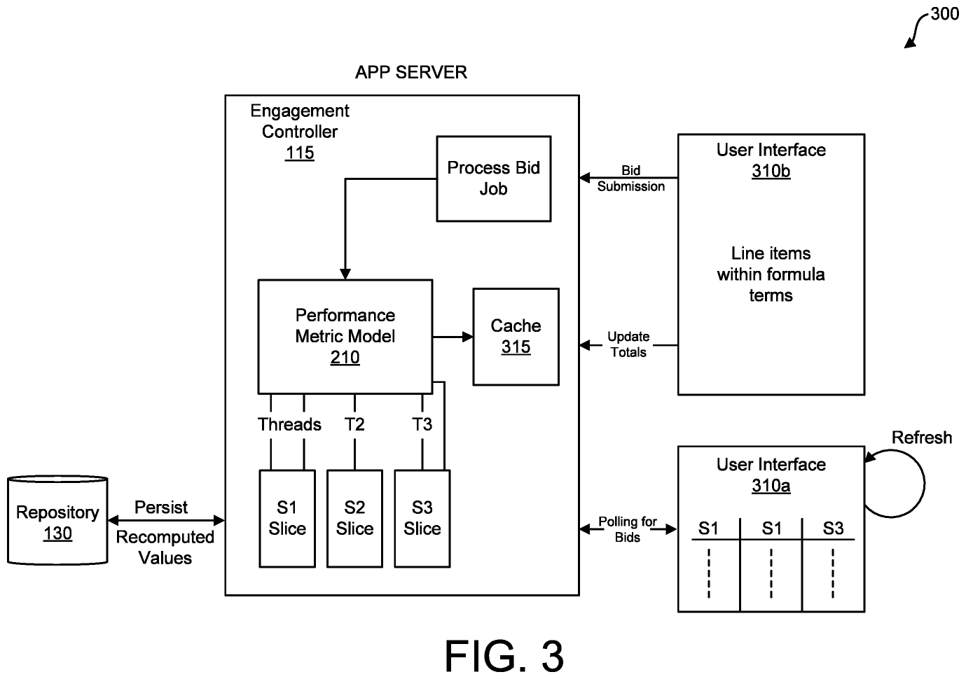

FIG. 3 depicts a block diagram illustrating an example architecture 300 of the procurement system 100, in accordance with some example embodiments. As shown in FIG. 3, the engagement controller 115 may be a part of a procurement software application hosted at an application server. The engagement controller 115 may apply the performance metric model 210 to compute, for each response received from a supplier invited to participate in the sourcing event 125, a performance metric indicative of a relative competitiveness of the response. As noted, the performance metric model 210 may be implemented based on one or more criteria specified by a purchaser associated with the sourcing event 125. Accordingly, the performance metric computed for a response, such as the first response 150a received from the second client device 120b or the second response 150b received from the third client device 120b, may indicate how well the terms of the response match the criteria specified by the purchaser associated with the sourcing event 125. As shown in FIG. 3, in some cases, the engagement controller 115 may be configured to cache more recent performance metrics, such as the performance metrics associated with the sourcing event 125, while historical performance metrics, such as those associated with previous sourcing events, may be persisted at the repository 130. As will be described in more details below, the engagement controller 115 may leverage data associated with current and past sourcing events stored in the repository 130 to drive individual supplier performance including by recommending modified terms that increase the likelihood of a response (e.g., electronic bid and/or the like) being awarded a sourcing event.

Referring again to FIG. 3, the engagement controller 115 may generate one or more user interfaces associated with the performance based engagement coordination of the sourcing event 125. For example, FIG. 3 shows a first user interface 310a, which may be displayed at the first client device 120a associated with the purchaser of the sourcing event 125 to provide an indication of the responses received from the suppliers participating in the sourcing event 125. In some cases, the first user interface 310a may depict the terms of each response as well as the corresponding performance metric and ranking. Alternatively and/or additionally, the engagement controller 115 may generate a second user interface 310b, which may be displayed at the second client device 120b and/or the third client device 120c associated with the individual suppliers invited to the participate in the sourcing event 125.

In some example embodiments, the second user interface 310b may be configured to receive one or more user inputs specifying the terms of a response (e.g., an electronic bid and/or the like) associated with the sourcing event 125. Moreover, the second user interface 310b may display one or more of a performance metric and/or a ranking determined by the engagement controller 115 based on the terms included in the response. For instance, upon receiving one or more user inputs specifying one or more of a total price, currency, quantity, quality, brand, discounts, and surcharge for a response to the sourcing event 125, the engagement controller 115 may apply the performance metric model 210 to compute a corresponding performance metric and/or ranking. In some cases, the second user interface 310b may provide a preview of the performance metric and/or ranking associated with the response such that one or more modifications to the response, for example, to increase the performance metric and/or ranking, may be made via the second user interface 310b.

As noted, in some example embodiments, the engagement controller 115 may apply a machine learning model to compute a performance metric for a response from a supplier participating in the sourcing event 125. Moreover, the engagement controller 115 may determine, based at least on the output of the machine learning model, one or more modifications to improve the performance metric of the response. In some cases, in addition to the performance metric and ranking associated with a supplier's current response, the engagement controller 115 may provide these recommendations in real time such that the supplier may submit a modified response with more competitive terms that are associated with a higher likelihood of being awarded the sourcing event 125.

In some example embodiments, the machine learning model may be trained to determine the performance metric of a response (e.g., electronic bid and/or the like) based on how well the terms of the response conform to the terms of one or more responses awarded one or more previous sourcing events, for example, by the purchaser of the sourcing event 125. Accordingly, the machine learning model may be trained based on data associated with past sourcing events stored in the repository 130, which may include past sourcing events awarded by the same purchaser associated with the sourcing event 125. For example, each training sample may correspond to a single sourcing event and may therefore include one or more of event data (e.g., title, description, region, start date, end date), line item data (e.g., commodity, discount amount, discount percentage, price, incumbent price, surcharge, delivery charge, bundle lot price, quantity), supplier data (e.g., turnover, time in operation, risk index, previous awards, incumbent price), bid data (e.g., line items, competitive term values, non-competitive term values), award data (e.g., supplier awarded, line items awarded, quantity of award, price of award), grading values (e.g., grade percentage determined by each line item, gradable terms for supplier rollup), and/or the like.

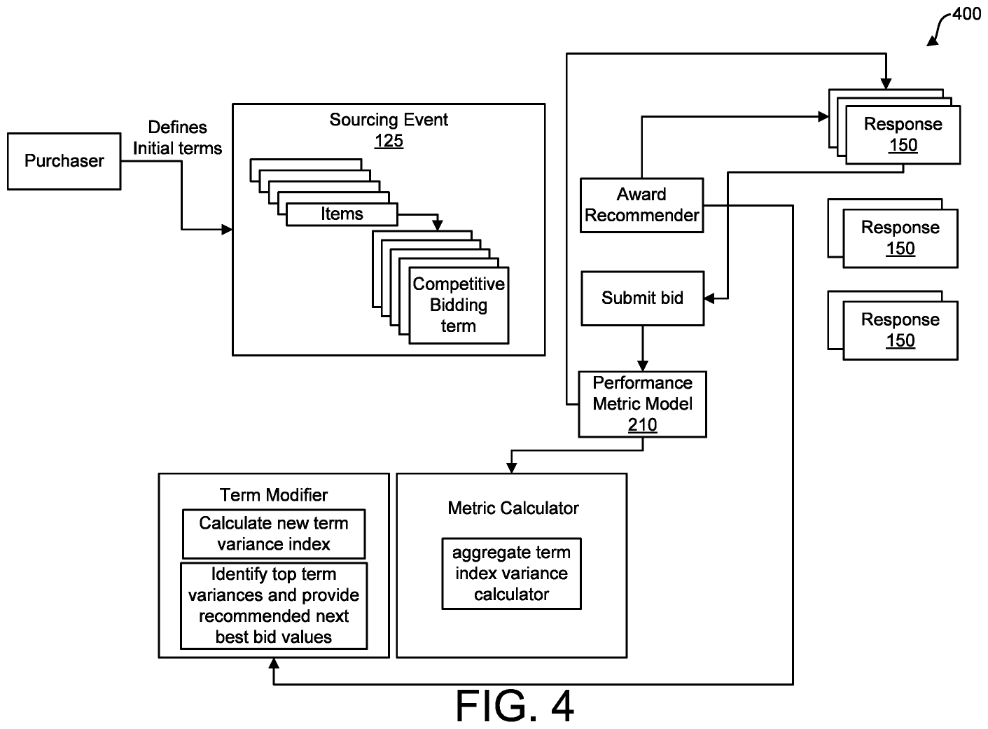

In some example embodiments, the machine learning model may be a regression model (e.g., a support vector machine (SMV) regression model, a ridge regression model, a lasso regression model, and/or the like) trained to calculate a variance between the terms of a current response (e.g., the first response 150a or the second response 150b) and those included in the responses awarded one or more prior sourcing events. To further illustrate, FIG. 4 depicts a block diagram illustrating an example of a dataflow within the procurement system 100, in accordance with some example embodiments. As shown in FIG. 4, the performance metric associated with the current response may correspond to a variance between the respective terms of these responses and the terms included in the responses awarded prior sourcing events associated with the same purchaser (and/or similar purchasers). In some cases, the output of the machine learning model may include term-specific variances indicating a variance between the individual terms of a current response and the corresponding terms in the responses awarded previous sourcing events. The terms associated with a maximum variance (and/or an above-threshold variance) may be identified as candidates for modification. For instance, if the delivery surcharge term of the current response exhibits the most variance relative to the delivery surcharge term in responses awarded previous sourcing events, the engagement controller 115 may generate a recommendation to modify the delivery surcharge term of the current response.

In some example embodiments, the data input into the machine learning model may undergo one or more preprocessing operations. For example, the input data, which may include one or more event data, line item data, supplier data, bid data, award data, and grading values, may be vectorized to denormalize the data. At least a portion of the input data may be encoded, for example, by applying one-hot encoding (or another encoding technique). Additional data cleaning techniques may be performed, for example, to identify covariant values, outlying values, null values (for replacement with mean and/or median values), and/or the like. In some cases, at least a portion of the input data may be enriched, for example, by mapping grading values for various terms, items, and/or suppliers to an index for subsequent learning and evaluation. Other examples of data enrichment may include feature scaling, data transformation, and dimensionality reduction and/or visualization.

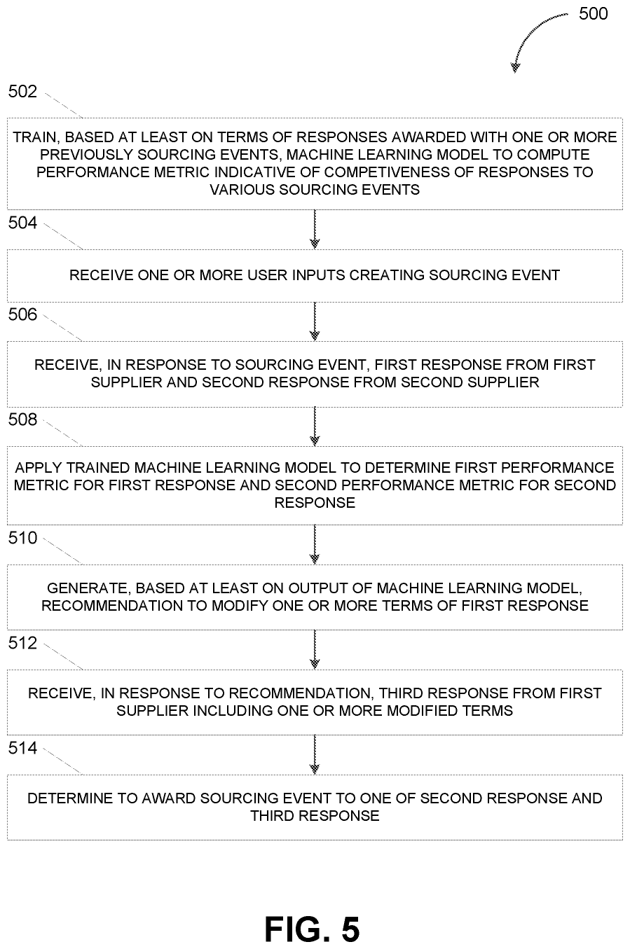

FIG. 5 depicts a flowchart illustrating an example of a process 500 for performance based engagement coordination of a sourcing event, in accordance with some example embodiments. Referring to FIGS. 1-5, the process 500 may be performed by the procurement engine 110, for example, the engagement controller 115 in order to coordinate multiple suppliers participating in a sourcing event, such as the sourcing event 125. For example, as noted, the procurement engine 110 may coordinate the sourcing event 125 created at the first client device 120a by at least inviting one or more suppliers to participate in the sourcing event 125, receiving responses (e.g., electronic bids and/or the like) from the participating suppliers such as a first response 150a from a second client device 120b and a second response 150b from a third client device 130c, and awarding the sourcing event 125 to one or more of the participating suppliers. In some example embodiments, the procurement engine 110 may leverage data associated with current and past sourcing events stored in the repository 130 to drive individual supplier performance during the sourcing event 125. For example, the engagement controller 115 may apply one or more machine learning models to implement, during the sourcing event 125, performance based engagement coordination.

At 502, the engagement engine 115 may train, based at least on terms of responses awarded with one or more previous sourcing events, a machine learning model to compute a performance metric indicative of a competitiveness of responses to various sourcing event. In some example embodiments, the engagement engine 115 may train a regression model (e.g., a support vector machine (SMV) regression model, a ridge regression model, a lasso regression model, and/or the like) based on training samples that correspond to one or more previous sourcing events and the responses awarded each sourcing event. For example, each training sample may include one or more of event data (e.g., title, description, region, start date, end date), line item data (e.g., commodity, discount amount, discount percentage, price, incumbent price, surcharge, delivery charge, bundle lot price, quantity), supplier data (e.g., turnover, time in operation, risk index, previous awards, incumbent price), bid data (e.g., line items, competitive term values, non-competitive term values), award data (e.g., supplier awarded, line items awarded quantity of award, price of award), grading values (e.g., grade percentage determined by each line item, gradable terms for supplier rollup), and/or the like. The machine learning model may be trained to determine a variance between the terms of a current response and the terms included in the responses awarded previous sourcing events. For instance, the performance metric associated with the current response may correspond to a variance between the respective terms of these responses and the terms included in the responses awarded previous sourcing events associated with the same purchaser (and/or similar purchasers).

At 504, the engagement engine 115 may receive one or more user inputs creating a sourcing event. For example, as shown in FIG. 1, the engagement engine 115 may receive, from the first client device 120a, one or more user inputs creating the sourcing event 125. The one or more user inputs may specify, for example, one or more of a title, description, region, start date, end date, and commodity for the sourcing event 125.

At 506, the engagement engine 115 may receive, in response to the sourcing event, a first response from a first supplier and a second response from a second supplier. For instance, in the example shown in FIG. 1, the engagement engine 115 may receive, from the second client device 120b, the first response 150a. Furthermore, the engagement engine 115 may receive, from the third client device 120c, the second response 150c. The first response 150a and the second response 150b may each include, for each line item included in the sourcing event 125, one or more terms. Examples of the terms associated with each line item may include total price, currency, quantity, quality, brand, discounts, and surcharge.

At 508, the engagement engine 115 may apply the trained machine learning model to determine a first performance metric for the first response and a second performance metric for the second response. In some example embodiments, the engagement engine 115 may apply the trained machine learning model to determine a first performance metric for the first response 150a received from the first supplier and a second performance metric for the second response 150b received from the second supplier. The first performance metric and the second performance metric may each indicate how well the terms of the corresponding responses match the terms of responses awarded the previous sourcing events. Accordingly, in some cases, the engagement controller 115 may generate, for example, the second user interface 310b displaying one or more of the first performance metric, a first supplier ranking corresponding to the first performance metric, the second performance metric, and a second supplier ranking corresponding to the second performance metric. This information may be provided in real time in order to encourage the submission of additional responses, including modified responses, with more competitive terms configured to improve each supplier's performance metric and relative ranking.

At 510, the engagement engine 115 may generate, based at least on an output of the machine learning model, a recommendation to modify one or more terms of the first response. In some example embodiments, in addition to the performance metric and ranking associated with a supplier's current response to the sourcing event 125, the engagement engine 115 may also determine, based at least on the output of the machine learning model, one or more modifications to the supplier's current response. For example, in some cases, the output of the machine learning model may include term-specific variances indicating a variance between the individual terms of the current response and the corresponding terms in the responses awarded the previous sourcing events. Accordingly, the engagement controller 115 may identify, as candidates for modification, the terms associated with a maximum variance (and/or an above-threshold variance). For instance, if the delivery surcharge term of the first response 150a exhibits a highest variance (and/or an above-threshold variance) relative to the delivery surcharge term associated with the responses awarded previous sourcing events, the engagement controller 115 may identify the delivery surcharge term of the first response 150a as a candidate for modification.

At 512, the engagement engine 115 may receive, in response to the recommendation, a third response from the first supplier including the one or more modified terms. For example, where the delivery surcharge term included in the first response 150a is identified as a candidate for modification (e.g., due to the delivery surcharge term being associated with a highest variance (and/or an above-threshold variance), the engagement engine 115 may generate a recommendation for the first supplier to modify the delivery surcharge term of the first response 150a and submit another response to the sourcing event 125 having the modified delivery surcharge term. Moreover, the engagement engine 115 may receive, from the second client device 120b, a third response 150c from the first supplier having a more competitive delivery surcharge term.

At 514, the engagement engine 115 may determine to award the sourcing event to one of the second response and the third response. In some example embodiments, the engagement engine 115 may determine to award the sourcing event 125 to one or more of the responses received from the suppliers participating in the sourcing event 125. For example, in some cases, the engagement engine 115 may determine to award the sourcing event 125 to one or more responses having the most favorable terms.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

### Example 1

A system, comprising: at least one data processor; and at least one memory storing instructions, which when executed by the at least one data processor, result in operations comprising: receiving, from a first client device associated with a first supplier, a first response to a sourcing event; preprocessing the first response by at least vectorizing at least a portion of data comprising the first response to denormalize the data; applying, to the preprocessed first response, a machine learning model to determine a first performance metric associated with the first response, the machine learning model being trained to determine, based at least on a first plurality of terms included in the first response, the first performance metric to indicate a relative competitiveness of the first response and at least a second response responsive to the sourcing event, the machine learning model being trained to determine a variance between the first plurality of terms included in the first response and a second plurality of terms comprising one or more responses awarded one or more previous sourcing events and to generate an output including a term-specific variance between each term of the first plurality of terms included in the first response and a corresponding term of a second plurality of terms comprising one or more responses awarded one or more previous sourcing events; identifying, based at least on the output of the machine learning model, one or more terms of the first plurality of terms as candidates for modification; and generating, for display at the first client device, a user interface including a recommendation to modify the one or more terms.

### Example 2

The system of Example 1, wherein the operations further comprise: receiving, in response to the recommendation, a third response from the first supplier, the third response including the one or more modified terms; and determining, based at least on a second plurality of terms comprising the second response and a third plurality of terms comprising the third response, to reward the sourcing event to one of the second response associated with the second supplier and the third response associated with the first supplier.

### Example 3

The system of any one of Examples 1 to 2, wherein the preprocessing of the first response further includes encoding at least a portion of the data comprising the first response.

### Example 4

The system of any one of Examples 1 to 3, wherein the preprocessing of the first response further includes identifying one or more covariant values, outlying values, and null values.

### Example 5

The system of Example 4, wherein the one or more terms identified as candidates for modification are identified based at least on the one or more terms being associated with a highest term-specific variance and/or an above-threshold term-specific variance.

### Example 6

The system of any one of Examples 1 to 6, wherein the operations further comprise: training, based at least on data associated with one or more previous sourcing events, the machine learning machine model.

### Example 7

The system of Example 6, wherein the data associated with the one or more previous sourcing events include an event data comprising at least one of title, description, region, start date, or end date.

### Example 8

The system of any one of Examples 6 to 7, wherein the data associated with the one or more previous sourcing events include a line item data comprising at least one of a commodity, discount amount, discount percentage, price, incumbent price, surcharge, delivery charge, bundle lot price, or quantity.

### Example 9

The system of any one of Examples 6 to 8, wherein the data associated with the one or more previous sourcing events include a supplier data comprising at least one of a turnover, time in operation, risk index, previous awards, or incumbent price.

### Example 10

The system of any one of Examples 6 to 9, wherein the data associated with the one or more previous sourcing events include a bid data comprising at least one of a line item, competitive term value, or non-competitive term value.

### Example 11

The system of any one of Examples 6 to 10, wherein the data associated with the one or more previous sourcing events include an award data comprising at least one of a supplier awarded, line item awarded, quantity of award, or price of award.

### Example 12

The system of any one of Examples 6 to 11, wherein the data associated with the one or more previous sourcing events include one or more grading values associated with each supplier and/or line item.

### Example 13

The system of any one of Examples 6 to 12, wherein the one or more previous sourcing events are associated with a same purchaser as the sourcing event.

### Example 14

The system of any one of Examples 1 to 13, wherein the machine learning model comprise a regression model.

### Example 15

The system of any one of Examples 1 to 14, wherein the machine learning model comprises one or more of a support vector machine (SMV) regression model, a ridge regression model, or a lasso regression model.

### Example 16

The system of any one of Examples 1 to 15, wherein the user interface is further generate to include the first performance metric and/or a first ranking of the first supplier corresponding to the first performance metric.

### Example 17

The system of any one of Examples 1 to 16, wherein the operations further comprise: receiving, from a second client device associated with a second supplier, the second response; and applying the machine learning model to determine a second performance metric associated with the second response.

### Example 18

The system of any one of Examples 1 to 17, wherein the operations further comprise: receiving, in response to the recommendation, one or more user inputs modifying the one or more terms; applying the machine learning model to determine an updated performance metric corresponding to the one or more modified terms; and generating the user interface to display, at the first client device, the updated performance metric.

### Example 19

A computer-implemented method, comprising: receiving, from a first client device associated with a first supplier, a first response to a sourcing event; preprocessing the first response by at least vectorizing at least a portion of data comprising the first response to denormalize the data; applying, to the preprocessed first response, a machine learning model to determine a first performance metric associated with the first response, the machine learning model being trained to determine, based at least on a first plurality of terms included in the first response, the first performance metric to indicate a relative competitiveness of the first response and at least a second response responsive to the sourcing event; the machine learning model being trained to determine a variance between the first plurality of terms included in the first response and a second plurality of terms comprising one or more responses awarded one or more previous sourcing events and to generate an output including a term-specific variance between each term of the first plurality of terms included in the first response and a corresponding term of a second plurality of terms comprising one or more responses awarded one or more previous sourcing events; identifying, based at least on the output of the machine learning model, one or more terms of the first plurality of terms as candidates for modification; and generating, for display at the first client device, a user interface including a recommendation to modify the one or more terms.

### Example 20

A non-transitory computer readable medium storing instructions, which when executed by at least one data processor, result in operations comprising: receiving, from a first client device associated with a first supplier, a first response to a sourcing event; preprocessing the first response by at least vectorizing at least a portion of data comprising the first response to denormalize the data; applying, to the preprocessed first response, a machine learning model to determine a first performance metric associated with the first response, the machine learning model being trained to determine, based at least on a first plurality of terms included in the first response, the first performance metric to indicate a relative competitiveness of the first response and at least a second response responsive to the sourcing event, the machine learning model being trained to determine a variance between the first plurality of terms included in the first response and a second plurality of terms comprising one or more responses awarded one or more previous sourcing events and to generate an output including a term-specific variance between each term of the first plurality of terms included in the first response and a corresponding term of a second plurality of terms comprising one or more responses awarded one or more previous sourcing events; identifying, based at least on the output of the machine learning model, one or more terms of the first plurality of terms as candidates for modification; and generating, for display at the first client device, a user interface including a recommendation to modify the one or more terms.

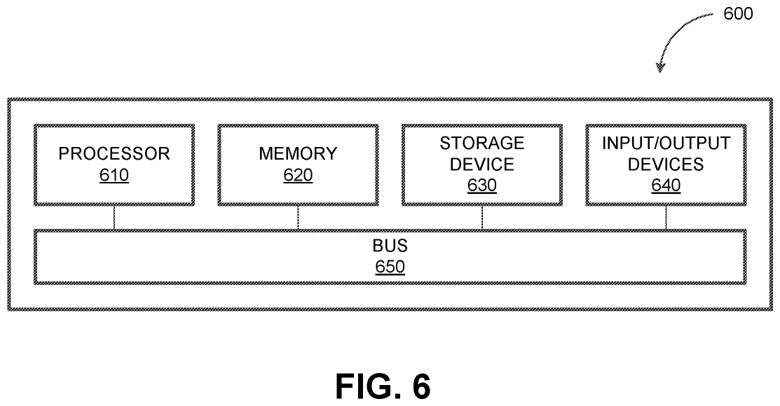

FIG. 6 depicts a block diagram illustrating a computing system 600, in accordance with some example embodiments. Referring to FIGS. 1-6, the computing system 600 can be used to implement the procurement engine 110 and/or any components therein.

As shown in FIG. 6, the computing system 600 can include a processor 610, a memory 620, a storage device 630, and an input/output device 640. The processor 610, the memory 620, the storage device 630, and the input/output device 640 can be interconnected via a system bus 650. The processor 610 is capable of processing instructions for execution within the computing system 600. Such executed instructions can implement one or more components of, for example, the procurement engine 110. In some implementations of the current subject matter, the processor 610 can be a single-threaded processor. Alternately, the processor 610 can be a multi-threaded processor. The processor 610 is capable of processing instructions stored in the memory 620 and/or on the storage device 630 to display graphical information for a user interface provided via the input/output device 640.

The memory 620 is a computer readable medium such as volatile or non-volatile that stores information within the computing system 600. The memory 620 can store data structures representing configuration object databases, for example. The storage device 630 is capable of providing persistent storage for the computing system 600. The storage device 630 can be a floppy disk device, a hard disk device, an optical disk device, or a tape device, or other suitable persistent storage means. The input/output device 640 provides input/output operations for the computing system 600. In some implementations of the current subject matter, the input/output device 640 includes a keyboard and/or pointing device. In various implementations, the input/output device 640 includes a display unit for displaying graphical user interfaces.

According to some implementations of the current subject matter, the input/output device 640 can provide input/output operations for a network device. For example, the input/output device 640 can include Ethernet ports or other networking ports to communicate with one or more wired and/or wireless networks (e.g., a local area network (LAN), a wide area network (WAN), the Internet).

In some implementations of the current subject matter, the computing system 600 can be used to execute various interactive computer software applications that can be used for organization, analysis and/or storage of data in various (e.g., tabular) format (e.g., Microsoft Excel®, and/or any other type of software). Alternatively, the computing system 600 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 640. The user interface can be generated and presented to a user by the computing system 600 (e.g., on a computer screen monitor, etc.).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

What is claimed is:

1. A system, comprising:
at least one processor; and
at least one memory including program code which when executed by the at least one processor provides operations comprising:
receiving, from a first client device associated with a first supplier, a first response to a sourcing event;
preprocessing the first response by at least vectorizing data comprising the first response to denormalize the data;
applying, to the preprocessed the first response, a machine learning model to determine a first performance metric associated with the first response, the machine learning model being trained to determine, based at least on a first plurality of terms included in the first response, the first performance metric to indicate a relative competitiveness of the first response and at least a second response responsive to the sourcing event, the machine learning model being trained to determine a variance between the first plurality of terms included in the first response and a second plurality of terms comprising one or more responses awarded one or more previous sourcing events and to generate an output including a term-specific variance between each term of the first plurality of terms included in the first response and a corresponding term of a second plurality of terms comprising one or more responses awarded one or more previous sourcing events;
identifying, based at least on the output of the machine learning model, one or more terms of the first plurality of terms as candidates for modification; and
generating, for display at the first client device, a user interface including a recommendation to modify the one or more terms.

2. The system of claim 1, wherein the operations further comprise:
receiving, in response to the recommendation, a third response from the first supplier, the third response including the one or more modified terms; and
determining, based at least on a second plurality of terms comprising the second response and a third plurality of terms comprising the third response, to reward the sourcing event to one of the second response associated with the second supplier and the third response associated with the first supplier.

3. The system of claim 1, wherein the preprocessing of the first response further includes encoding at least a portion of the data comprising the first response.

4. The system of claim 1, wherein the preprocessing of the first response further includes identifying one or more covariant values, outlying values, and null values.

5. The system of claim 4, wherein the one or more terms identified as candidates for modification are identified based at least on the one or more terms being associated with a highest term-specific variance and/or an above-threshold term-specific variance.

6. The system of claim 1, wherein the operations further comprise:
training, based at least on data associated with one or more previous sourcing events, the machine learning machine model.

7. The system of claim 6, wherein the data associated with the one or more previous sourcing events include an event data comprising at least one of title, description, region, start date, or end date.

8. The system of claim 6, wherein the data associated with the one or more previous sourcing events include a line item data comprising at least one of a commodity, discount amount, discount percentage, price, incumbent price, surcharge, delivery charge, bundle lot price, or quantity.

9. The system of claim 6, wherein the data associated with the one or more previous sourcing events include a supplier data comprising at least one of a turnover, time in operation, risk index, previous awards, or incumbent price.

10. The system of claim 6, wherein the data associated with the one or more previous sourcing events include a bid data comprising at least one of a line item, competitive term value, or non-competitive term value.

11. The system of claim 6, wherein the data associated with the one or more previous sourcing events include an award data comprising at least one of a supplier awarded, line item awarded, quantity of award, or price of award.

12. The system of claim 6, wherein the data associated with the one or more previous sourcing events include one or more grading values associated with each supplier and/or line item.

13. The system of claim 6, wherein the one or more previous sourcing events are associated with a same purchaser as the sourcing event.

14. The system of claim 1, wherein the machine learning model comprise a regression model.

15. The system of claim 1, wherein the machine learning model comprises one or more of a support vector machine (SMV) regression model, a ridge regression model, or a lasso regression model.

16. The system of claim 1, wherein the user interface is further generate to include the first performance metric and/or a first ranking of the first supplier corresponding to the first performance metric.

17. The system of claim 1, wherein operations further comprise:
receiving, from a second client device associated with a second supplier, the second response; and
applying the machine learning model to determine a second performance metric associated with the second response.

18. The system of claim 1, wherein the operations further comprises:
receiving, in response to the recommendation, one or more user inputs modifying the one or more terms;
applying the machine learning model to determine an updated performance metric corresponding to the one or more modified terms; and
generating the user interface to display, at the first client device, the updated performance metric.

19. A computer-implemented method, comprising:
receiving, from a first client device associated with a first supplier, a first response to a sourcing event;
preprocessing the first response by at least vectorizing at least a portion of data comprising the first response to denormalize the data;
applying, to the preprocessed first response, a machine learning model to determine a first performance metric associated with the first response, the machine learning model being trained to determine, based at least on a first plurality of terms included in the first response, the first performance metric to indicate a relative competitiveness of the first response and at least a second response responsive to the sourcing event, the machine learning model being trained to determine a variance between the first plurality of terms included in the first response and a second plurality of terms comprising one or more responses awarded one or more previous sourcing events and to generate an output including a term-specific variance between each term of the first plurality of terms included in the first response and a corresponding term of a second plurality of terms comprising one or more responses awarded one or more previous sourcing events;
identifying, based at least on the output of the machine learning model, one or more terms of the first plurality of terms as candidates for modification; and
generating, for display at the first client device, a user interface including a recommendation to modify the one or more terms.

20. A non-transitory computer readable medium storing instructions, which when executed by at least one data processor, result in operations comprising:
receiving, from a first client device associated with a first supplier, a first response to a sourcing event;
preprocessing the first response by at least vectorizing at least a portion of data comprising the first response to denormalize the data;
applying, to the preprocessed first response, a machine learning model to determine a first performance metric associated with the first response, the machine learning model being trained to determine, based at least on a first plurality of terms included in the first response, the first performance metric to indicate a relative competitiveness of the first response and at least a second response responsive to the sourcing event, the machine learning model being trained to determine a variance between the first plurality of terms included in the first response and a second plurality of terms comprising one or more responses awarded one or more previous sourcing events and to generate an output including a term-specific variance between each term of the first plurality of terms included in the first response and a corresponding term of a second plurality of terms comprising one or more responses awarded one or more previous sourcing events;
identifying, based at least on the output of the machine learning model, one or more terms of the first plurality of terms as candidates for modification; and
generating, for display at the first client device, a user interface including a recommendation to modify the one or more terms.
